(19) United States
(12) Patent Application Publication
(10) Pub. No.: US 2026/0038481 A1
(43) Pub. Date: Feb. 5, 2026

(54) AVIATION ANOMALY DETECTION SYSTEM AND RELATED METHODS

(71) Applicant: Eagle Technology, LLC, Melbourne, FL (US)

(72) Inventors: KEVIN R. NIEWOEHNER, STAFFORD, VA (US); JOSIAH WONG, ORLANDO, FL (US); KEVIN L. FOX, PALM BAY, FL (US); MARK D. RAHMES, MELBOURNE, FL (US)

(21) Appl. No.: 18/788,568

(22) Filed: Jul. 30, 2024

(51) Int. Cl. G10L 15/06; G08B 23/00; G08G 5/00

(52) U.S. Cl. CPC G10L 15/063; G08B 23/00; G08G 5/26

(57) ABSTRACT

An aviation anomaly detection system may include an interface configured to receive audio communications between an air traffic control station and a plurality of aircraft, a speech-to-text converter configured to convert the received audio communications from the interface to text data, and a processor. The processor may be configured to determine at least one aviation anomaly from the text data with a variational autoencoder (VAE) deep learning model, and generate an alert based upon the at least one aviation anomaly.

### TECHNICAL FIELD

The present disclosure relates to avionics, and, more particularly, to aircraft monitoring systems and related methods.

### BACKGROUND

Aviation safety margins may be challenged by numerous factors, e.g., changing technology, increased flight travel, etc. Any of these factors can lead to human error or reduced situational awareness on the part of pilots and/or air traffic controllers.

As a result, various approaches have been developed to monitor anomalies in the avionics environment. One example is U.S. Pat. No. 11,783,817, which is directed to a processor to identify an anomaly in one or more communications. The processor may monitor communications for an utterance. The processor may perform natural language processing (NLP) on the utterance, generate an understanding of the utterance using natural language understanding (NLU), detect the anomaly from the understanding of the utterance, and execute a response upon detecting the anomaly.

Despite the existence of such systems, further developments in anomaly detection for aviation may be desirable in certain applications.

### SUMMARY

An aviation anomaly detection system may include an interface configured to receive audio communications between an air traffic control station and a plurality of aircraft, a speech-to-text converter configured to convert the received audio communications from the interface to text data, and a processor. The processor may be configured to determine at least one aviation anomaly from the text data with a variational autoencoder (VAE) deep learning model, and generate an alert based upon the at least one aviation anomaly.

In an example implementation, the VAE deep learning model may comprise a plurality of VAE deep learning models including at least some of an Adaptive Moment Estimation (ADAM) deep learning VAE model, a Stochastic Gradient Descent with Momentum (SGDM) deep learning VAE model, and a root mean square propagation (RMSProp) deep learning VAE model. Furthermore, the processor may be configured to select a given VAE deep learning model from among the plurality thereof based upon a game theory reward matrix, for example.

In one implementation, the at least one aviation anomaly may comprise at least one of a pilot readback error and a pilot deviation error. In an example embodiment, the processor may be further configured to determine aircraft locations from the text data, and determine the at least one aviation anomaly based upon relative positions of determined aircraft locations.

In accordance with one example, the VAE deep learning model may be trained based upon a plurality of air traffic communications generated from a machine learning (ML) large language model (LLM). The interface may be configured to receive aircraft ground control audio communications, and air route control audio communications, in an example implementation.

A related aviation anomaly detection method may include receiving audio communications between an air traffic control station and a plurality of aircraft at an interface, and converting the received audio communications from the interface to text data at a speech-to-text converter. The method may further include using a processor to determine at least one aviation anomaly from the text data with a VAE deep learning model, and generate an alert based upon the at least one aviation anomaly.

A related non-transitory computer-readable medium may have computer-executable instructions for causing a processor to perform steps including receiving text data converted from audio communications between an air traffic control station and a plurality of aircraft. The steps may further include determining at least one aviation anomaly from the text data with a VAE deep learning model, and generating an alert based upon the at least one aviation anomaly.

### BRIEF DESCRIPTION OF THE DRAWINGS

FIG. 1 is a schematic block diagram of an avionics anomaly detection system in accordance with an example embodiment.

FIG. 2 is a schematic block diagram of a variational autoencoder (VAE) which may be used in the avionics anomaly detection system of FIG. 1.

FIG. 3 is a flow diagram illustrating example steps which may be performed by the avionics anomaly detection system of FIG. 1 in accordance with an example implementation.

FIG. 4 is a layer diagram of an example encoder/decoder implementation for the VAE of FIG. 2.

FIG. 5 is a schematic block diagram of a machine learning framework which may be used with the avionics anomaly detection system of FIG. 1 in accordance with an example embodiment.

FIG. 6 is a schematic block diagram of an ensemble classification configuration which may be used with the machine learning framework of FIG. 5 in accordance with an example embodiment.

FIG. 7 is a graph of VAE latent space samples in an example implementation where successful learning is present by the avionics anomaly detection system of FIG. 1.

FIG. 8 is a graph of VAE latent space samples in an example implementation where poor learning is present by the avionics anomaly detection system of FIG. 1.

FIG. 9 is a graph of latent space mean showing normal cluster sample points and anomaly sample points in an example implementation.

FIG. 10 is a receiver operating characteristic (ROC) curve illustrating true positive vs. false positive rates achieved by the avionics anomaly detection system of FIG. 1 in an example embodiment.

FIG. 11 is a schematic block diagram illustrating a large language model (LLM) training approach for VAE machine learning models which may be used by the avionics anomaly detection system of FIG. 1 in an example embodiment.

FIG. 12 is a flow diagram illustrating example method aspects associated with the avionics anomaly detection system of FIG. 1.

### DETAILED DESCRIPTION

The present description is made with reference to the accompanying drawings, in which exemplary embodiments are shown. However, many different embodiments may be used, and thus the description should not be construed as limited to the particular embodiments set forth herein. Rather, these embodiments are provided so that this disclosure will be thorough and complete. Like numbers refer to like elements throughout.

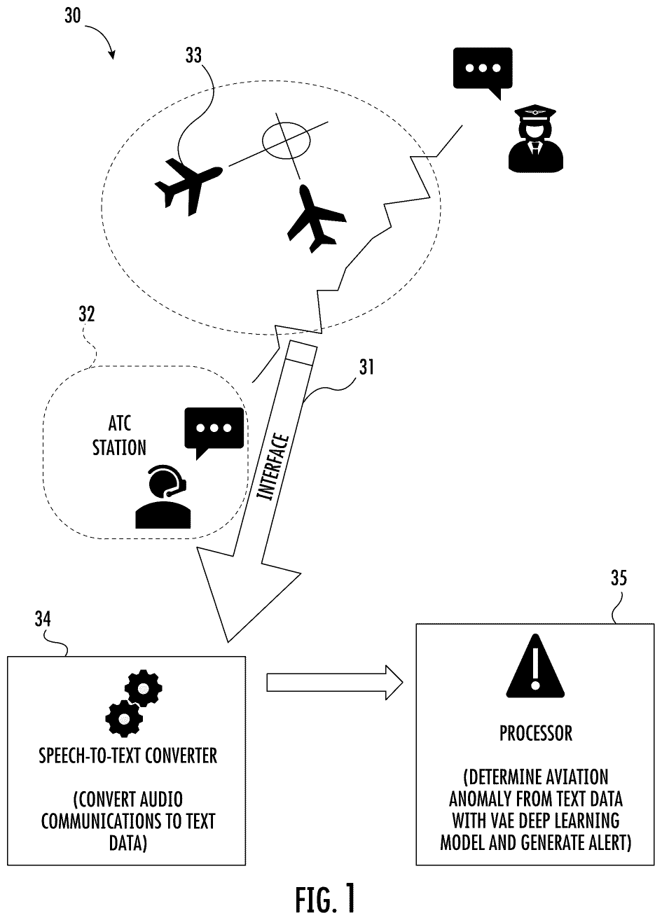

Referring initially to FIG. 1, an avionics anomaly detection system 30 is first described. By way of background, aviation safety is under constant pressure to improve, while being challenged by factors such as airspace complexity, high-density flight operations, technology refresh and infrastructure modernization, proximal operation of legacy aircraft with new entrants, and continued pressure to improve operating margins while navigating increasingly narrow safety margins. An area where recent data indicates at best correlation, and potentially causation, is safety margin impairment due to human factors. Recent reports have drawn attention to the disturbing frequency of documented near-misses occurring on a near-daily basis within the U.S. national airspace system (NAS). Whether due to a garbled radio message, loss of situational awareness, insufficient training, or sensory overload, there is a need for improved approaches to reduce such occurrences within the NAS.

While each safety event cited is unique, clear patterns of causation exist. One nexus of safety-escape causation is the disconnect that can occur between NAS procedures, situational awareness, and low-fidelity air-ground communications. This nexus is further exacerbated when differing levels of operational proficiency interact or procedural deviations by either a flight crew or air traffic controller occur. Most of these occur with negligible safety margin impairment. However, like any systems analysis, eroding safety margins can create a quality or operational escape under certain circumstances. Under this situation, it would be helpful to have some executive oversight to draw attention to a margin degradation and need for corrective action.

The aviation anomaly detection system 30 may advantageously be used to provide such oversight to pilots and/or air traffic controllers. The system 30 illustratively includes an interface 31 configured to receive audio communications between air traffic controllers at an air traffic control (ATC) station 32 and pilots in aircraft 33. The interface 31 may be a radio frequency (RF) interface in some embodiments that receives RF communications from the pilot and/or air traffic controllers. In some embodiments, air traffic controller audio communications could be communicated directly to the interface 31 (e.g., over a wired or wireless network), and in some embodiments the interface may also receive text messages (e.g., pre-departure clearance (PDC) messages) as well which may also be processed as part of the anomaly detection operations in some embodiments. For the audio communications, a speech-to-text converter 34 is configured to convert the received audio communications from the interface 31 to text data. The converter 34 may perform Automatic Speech Recognition (ASR) to generate text transcriptions of ATC communications in real-time, for example. A processor 35 is configured to determine one or more aviation anomalies from the text data with a variational autoencoder (VAE) deep learning model, as will be discussed further, and generate an alert based upon determined aviation anomalies. The various components of the system may be local to an air traffic control center and/or distributed among different locations (e.g., at the planes 33, in cloud computing clusters, etc.).

The system 30 may advantageously leverage Large Language Models (LLMs) and Deep Learning (DL) in the context of aviation safety or anomaly detection. In one example implementation, the system 30 provides for air-ground (and ground-ground) communications analyses enabled by the coupling of text analytics trained on synthetic data generated by LLMs with real-time surveillance, NAS procedural constraints, and airspace management objectives. The system 30 may use artificial intelligence (AI)/machine learning (ML) to proactively identify safety risks from air traffic communications and then alert ATCs and flight crews to the need for mitigating action.

Language Models (LMs) are representations of natural human language and are typically used to predict the next word in a sequence. LLMs are enabled by the Transformer model architecture, which is a set of neural networks (NNs) including an encoder and a decoder with self-attention capabilities. The encoder and decoder extract meanings from a sequence of text and understand the relationships between words and phrases in the text. Transformer LLMs perform self-learning, and through this process learn to understand basic grammar, languages, and knowledge. Transformers process entire sequences in parallel, allowing data scientists to use GPUs to train transformer-based LLMs, reducing training time of the final language model. The Transformer NN architecture enables the use of very large language models with billions of parameters. The resulting LLMs may be used to process and respond to complex humanlike prompts by generating a human-like response in a natural human language. LLMs have facilitated the general trend of increasing performance on natural language tasks by increasing the number of parameters trained by the language model.

Referring to the diagram 100 of FIG. 11, two approaches for training LLMs for a given task include traditional fine-tuning and prompting. In traditional finetuning, an LLM is first trained on a large corpus of unlabeled text data through a process called pretraining, and then it is further trained to be knowledgeable about a specific domain through supervised learning on a domain-specific corpus through a process called fine-tuning. In prompt-based training, a pretrained LLM is adapted to a specific task or domain through zero-shot or few-shot learning. Few-shot learning provides a few examples of desired input-output examples or additional information through preliminary prompts to the LLM before requesting responses from the LLM in subsequent prompts.

In contrast, zero-shot learning or augmented prompting employs strategies to obtain specific outputs by carefully framing the prompt without providing examples a priori. An example of augmented prompting is chain of thought (CoT) prompting, which prompts the LLM to provide a chain of statements explaining intermediate reasoning that leads the LLM to its ultimate conclusion. The diagram 100 shows the process of obtaining a pretrained LLM, and from it obtaining either a fine-tuned LLM through traditional fine-tuning or an assistant model through few-shot learning.

Few-shot and zero-shot learning are considered emergent behaviors of LLMs, which are capabilities that manifest as a result of training a sufficiently large model rather than explicitly designing or programming the model to possess or learn such capabilities. Other emergent abilities that appear in LLMs of sufficient size include multi-task language understanding, instruction following in new tasks, and program execution. Both few-shot and zero-shot learning approaches may be used for training LLMs for use by the system of FIG. 1, as will be discussed further below.

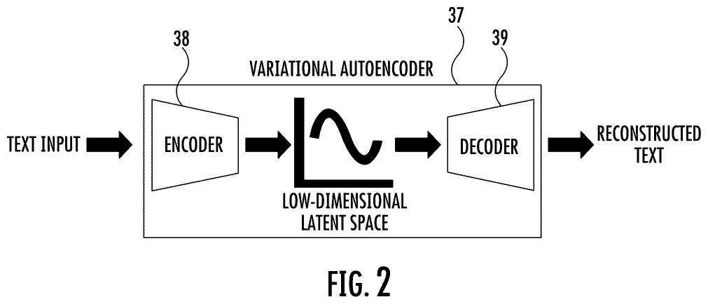

Referring additionally to FIG. 2, in the present example, a VAE machine learning approach is employed for anomaly detection. More particularly, the processor 35 combines text analytics with a VAE 37 and analyzes the latent space to determine outliers in an aviation safety application. The VAE 37 assumes that the source data has some sort of underlying probability distribution (such as Gaussian), and then attempts to find the parameters of the distribution.

The VAE 37 network architecture illustratively includes two parts, namely an encoder 38 and a decoder 39. The encoder 38 is responsible for learning a mapping from raw text data to a low-dimensional latent-space encoding that explains as much of the data as possible. The decoder 39 is responsible for learning the inverse mapping that takes as its input a single sample from the latent space and reconstructs the original text input. The VAE 37 learns a probability distribution on the latent space such that all text inputs in a training dataset presented to the VAE can be encoded into the learned latent space and then successfully decoded back into the original text.

Optimizing latent space using VAEs provides a way to help test anomaly detection. Anomaly detection strategies seek to measure reconstruction loss, which measures how “different” from a typical “normal” sample a given text input appears to the VAE 37. During training, the VAE 37 learns from text samples labeled as “normal”. When unlabeled samples are presented to the VAE 37 during testing, the model uses its encoder 38 to convert the text samples into their latent space encoding, and then it decodes them back to text. The “reconstruction loss” represents the difference between the original text and the reconstructed text. Normal text samples will have low reconstruction loss. Anomalous text samples cannot be reconstructed sufficiently, and reconstruction loss increases.

The system 30 may advantageously enhance the situational awareness capabilities of air traffic controllers by monitoring real-time ATC communications, identifying anomalous and potentially safety-critical situations, and raising an appropriate alert to the cognizant air traffic controller and flight crews. In this way, the system 30 may act as an assistant to air traffic controllers to confirm or elevate missed risk potentials, thereby decreasing time to decision, increasing time for corrective action, and providing a more effective focus for air traffic controllers and/or pilots. With the addition of LLMs, alerts may also include recommended actions for mitigating identified risks.

The act of processing human natural language in air traffic communication requires specific inputs and processing steps to determine whether a given situation requires increased attention by an air traffic controller. The present aviation anomaly detection system may receive input via the interface 31 from two input frameworks, namely the air traffic communication framework and the operational regulatory framework. The air traffic communication framework provides audio streams from air-ground communications which are converted into analyzable text transcriptions by the speech-to-text converter 34. This text data may then be processed by LLMs in an LLM virtual space to dynamically identify relevant actors, entities, speaker intentions, and other information pertinent to evaluating a situation's safety status. The operational regulatory framework is a static codification of the aviation operational standards that govern industry expectations and dictate flight safety constraints. These are defined in joint orders and other command media enforced by the FAA. Both frameworks are available for the purpose of monitoring communications for discrepancies in expected operational behavior.

To determine whether a situation requires increased attention or intervening action by an air traffic controller or flight crew, two questions may be answered:
1. Are all aircraft and flight crews compliant with orders issued by the air traffic controller?
2. Does the execution of ATC orders enable all aircraft to maintain safe separation and operations for the duration of operational execution?

Two modules answer both of these questions in the anomaly detection pipeline, in the procedural discrimination space and flight dynamics discrimination space, respectively, before performing a real-time operational safety assessment. During this assessment, if an anomaly relating to a safety concern has been identified, then an appropriate alerting mechanism may be activated to notify the appropriate air traffic controller and flight crews that the immediate situation requires their attention, and that action should be taken to mitigate safety risks. The nature of the alert (e.g., text-based display, light display, auditory signal) will depend on the role and personal preferences of all actors involved.

More particularly, the system 30 provides a text analytics anomaly detection pipeline that discriminates between nominal and off-nominal air traffic communications. In an example embodiment, the processor 35 may be implemented as a standalone anomaly detection module corresponding to the VAE-LLM Procedural Discrimination Space which processes conversations received from the air traffic communication framework. The processor 35 may also reference content from the operational regulatory framework.

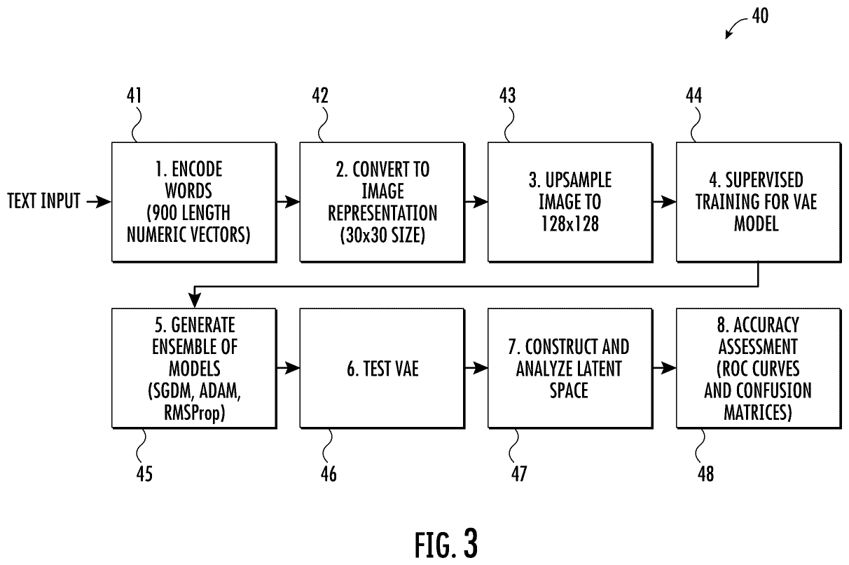

Referring additionally to the flow diagram 40 of FIG. 3, the present anomaly detection framework advantageously combines both text analytics and anomaly detection methodologies. In the illustrated anomaly detection training and evaluation approach, incoming text data may be preprocessed in some embodiments to add parts of speech, normalize words, erase punctuation, and/or remove stop words. Next, the words may be converted to numeric encodings to allow the data to be more easily processed by the VAE (Step 1, Block 41). Then, a two-dimensional representation (here of size 30×30) of the numerical encodings is generated (Step 2, Block 42) and then up-sampled to a larger image (here of size 128×128) (Step 3, Block 43) to take advantage of convolutional filters, which are used in the VAE 37 model architecture.

Supervised learning (Step 4, Block 44) may be used to generate a VAE model with the characteristics of nominal air traffic communications. Once the VAE model has been trained, it will be able to process air traffic communications and determine if they correspond to a nominal or off-nominal scenario.

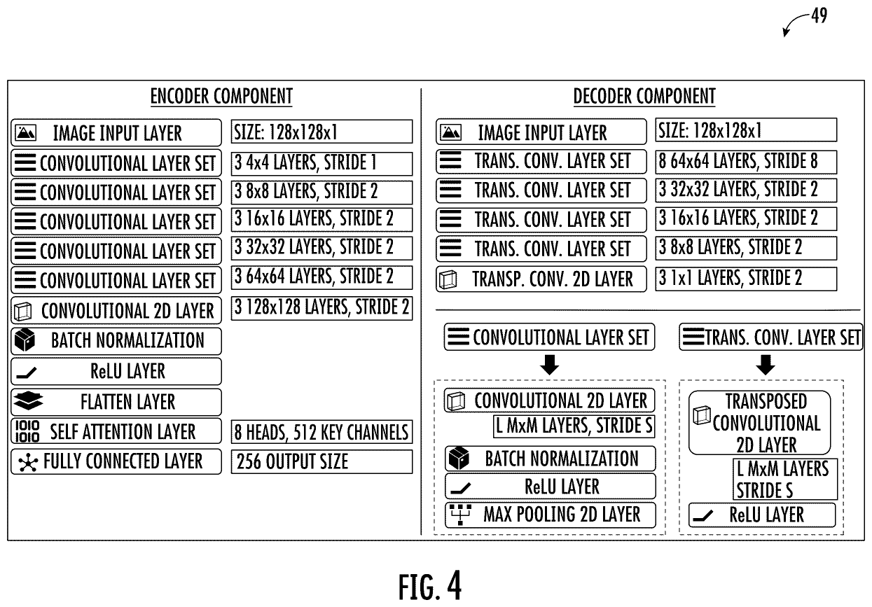

An example configuration of deep learning layers which may be used in the encoder 38 and decoder 39 of the VAE 37 architecture is shown in the layer diagram 49 of FIG. 4. The encoder 38 generates a compressed representation of the input data utilizing various weights and biases. Weights are the parameters within a neural network that transform input data within the network's hidden layers. A neural network is made up of a series of nodes. Within each node is a set of inputs, weights, and bias values. The weights and bias values in the nodes of each layer are modified during machine learning.

One beneficial layer in the VAE models is multi-head self-attention layer. The heads help encode contextual relationships between types of words, such as between adjectives and nouns, between adverbs and verbs, between bigrams, etc. This layer enhances the accuracy performance with deep connections in the layers. In an example implementation, eight attention heads, 512 channels, and 128 dimensions were used as model parameters, although different parameters may be used in different embodiments.

The compressed representation of the input data is called the hidden vector. The mean and variance from the hidden vector are sampled and learned by the convolutional neural network (CNN), which processes images encoding the text data. The convolutional layers are helpful in determining the similarity of different features.

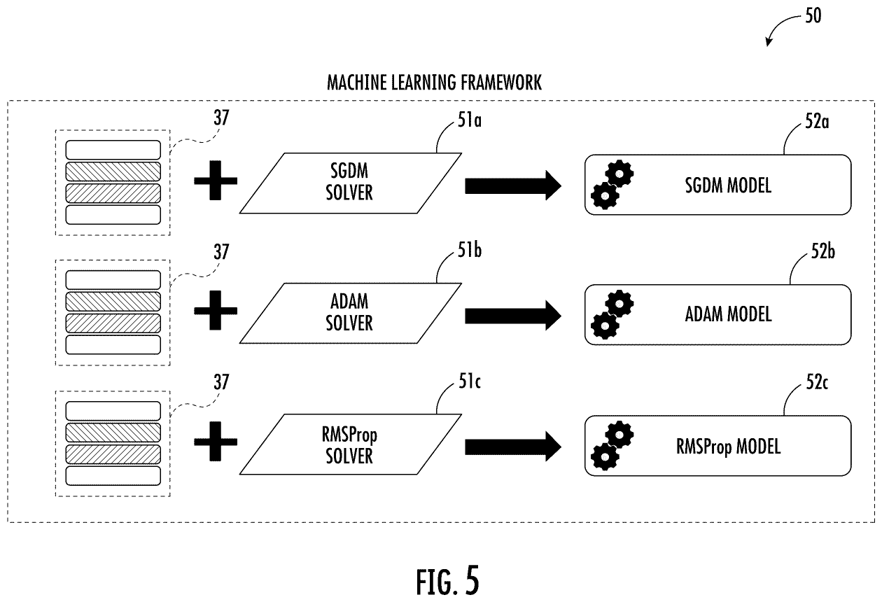

Referring additionally to an example machine learning framework 50 of FIG. 5, an ensemble of models with different solvers is created (Step 5, Block 45) with each model using the VAE model architecture 37. In the illustrated example, three different gradient descent solvers are used, namely Adaptive Moment Estimation (ADAM), Stochastic Gradient Descent with Momentum (SGDM), and Root Mean Square Propagation (RMSprop) solvers.

In an example embodiment, each model 52a-52c may be trained with 80% of the normal test samples and tested with 20% of the normal samples plus the abnormal samples. The VAE 37 may only need to train with normal data. A given text sample is determined by the VAE 37 to be normal or anomalous based on how different it is compared with a typical normal sample.

An optimal game theoretic linear program implementation may then be used to choose the solver 51a-51c from the ensemble of models 52a-52c with least error. The best model 52a-52c to believe for prediction can be chosen on a per sample basis. A linear program may be used to determine which model to weight more heavily, for example. This optimization may perform better than any single classifier. Linear optimization is useful for solving game theory problems and finding optimal strategies.

A reward matrix ‘A’ is constructed and solved with linear programming. The A matrix may include confidence or error values from predicted responses of several ML classifiers. Once the best classifier has been chosen, it is applied to the test data. This helps ensure that the best algorithm is always used to process incoming data. By way of example, an interior-point algorithm, such as the primal-dual method, may be used which is feasible for convergence.

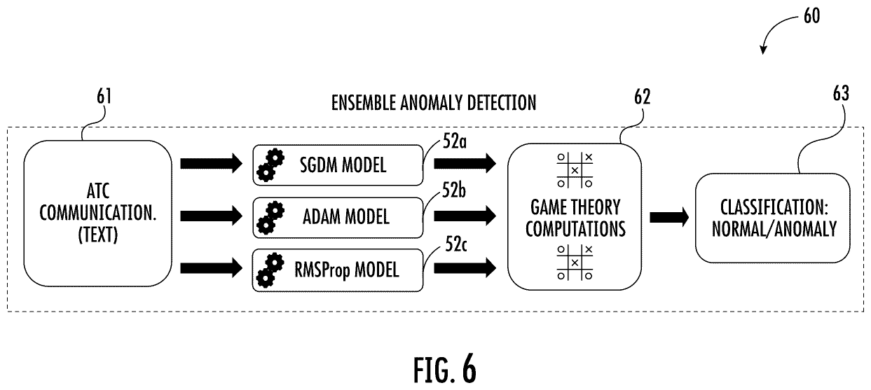

Given the normal/anomalous predictions of all three VAE models 52a-52c for a given text sample, a single most promising prediction from the ensemble of solvers 51a-51c may be generated, as illustrated in the ensemble classification diagram 60 of FIG. 6. Here, air/ground control traffic communications 61 in text format are input to the VAE models 52a-52c. A game theory module 62 performs the game theory computations, from which a classification 63 (normal or anomaly) is derived.

Given the ensemble anomaly detection configuration, a determination may be made as to how well the system 30 can distinguish between normal and anomalous text samples. This is done by plotting the samples in the dataset within a visualized latent space, and then analyzing the proportion of normal and anomalous text samples that the system 30 correctly classifies.

By way of example, a statistical Z-test may be used to analyze the p-value to determine if a given test sample belongs to the normal data distribution (Step 6, Block 46). A sample is determined to be an anomaly if the likelihood probability of its membership in the normal sample distribution is sufficiently small. Significance levels (p-values) may be used to determine if the new sample belongs to the normal distribution. In null hypothesis significance testing, the p-value is the probability of obtaining test results at least as extreme as the results observed, under the assumption that the null hypothesis (i.e., that the text sample is normal) is correct. A very small p-value means that such an extreme observed outcome would be very unlikely under the null hypothesis.

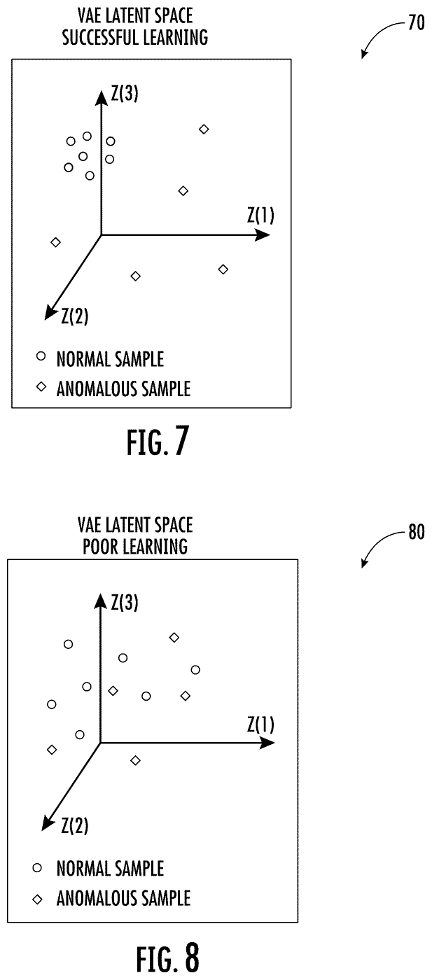

Principal component analysis (PCA) of the hidden vector allows for the visualization of n-dimensional point clusters, preferably 3-D point clusters, in the latent space in order to observe and compute maximum separation (Step 7, Block 47). If the VAE 37 learned successfully, then it will be able to plot all data samples within its internal latent space such that all normal data samples appear close together while anomalous data points are further away from the normal samples cluster. The diagrams 70 and 80 of FIGS. 7 and 8 respectively show two example visualizations-one where the VAE 37 has learned an internal latent space representation that successfully separates anomalous data samples from normal ones, and one where the VAE has learned poorly, and normal samples are not separable from anomalous ones in the learned latent space.

To determine the overall accuracy of the system 30 across the entire test set, Receiver Operating Characteristic (ROC) curves may be used. Given various combinations of normal and anomalous samples, the ROC curve measures how well the system correctly classifies normal samples as normal while correctly classifying anomalous samples as anomalous. The Area Under the Curve (AUC) is used to provide a single summary performance metric for the ROC curve. The closer it is to 1, the better the prediction. The AUC is commonly used to compare the performance of different classifiers.

Various datasets may be selected and preprocessed for use by the anomaly detection algorithm. For example, data may be selected that captures normal and anomalous scenarios, the latter involving events that indicate a safety risk or required intervention by an air traffic controller. Example datasets which may be leveraged include the air traffic controllers (ATCO) public dataset, LiveATC dataset, and an LLM-generated synthetic dataset, as will be discussed further below.

In an example use case, a conversation is considered to be the collection of time-adjacent utterances by at least two speakers. A conversation has a single arbitrary starting and ending point. A single utterance is audio communication (one or more sentences) by exactly one speaker that begins and ends in silence. Consecutive utterances may be made by the same speaker if there is silence between utterances. While it is possible that two or more speakers may be speaking simultaneously, we assume for simplicity that such occurrences are rare. Otherwise, we apply blind-source-separation algorithms to discriminate multiple speaker utterances.

For the present example, a single conversation is classified as normal or nominal if it does not contain verbal indicators of elevated safety risks or abnormal aircraft operational behavior. A conversation is considered anomalous or off-nominal if a safety risk is identified by one of the speakers or if a situation requires further inquiry or guidance from the air traffic controller.

For the present example, a synthetic dataset was created using the OpenAI API to autogenerate sample conversations between an air traffic controller and one or more pilots in both normal and anomalous situations. The gpt-3.5-turbo model was used with a temperature of 0.90 to increase the diversity of sample conversations. (A temperature of 0.0 has no diversity, while a temperature of 1.0 has maximum diversity.)

A dataset with 550 normal conversations and 550 anomalous conversations was generated, which were evenly divided across the 11 anomalous situation types. Each conversation was converted into a single string with a delimiter separating utterances and another delimiter separating a speaker from the message content. This is an example conversation: “ATC::Delta Niner Niner, you are cleared to land.; Pilot::Cleared to land, Delta Niner Niner.; . . . ” Table I below includes partial snippets of a conversation that was generated by ChatGPT for an anomalous exemplar scenario.

| Ref | Anomalous | | |
|---|---|---|---|
| ID | Situation | Speaker | Message |
| 1 | Pilot | ATC | Good morning, Atlas 123, this is |
| | Readback | | Tower. You are cleared for takeoff on |
| | Error | | Runway 27-Right. Wind is calm, |
| | | | altimeter is 29.92. Departure |
| | | | frequency is 118.1. Have a safe |
| | | | flight. |
| | | Pilot | Tower, Atlas 123, roger. Cleared for |
| | | | takeoff on Runway 27-Left. Departure |
| | | | frequency 118.1. Thank you. |
| | | ATC | Correction, Atlas 123, you are |
| | | | cleared for takeoff on Runway 27- |
| | | | Right, not 27-Left. Confirm you copy. |
| | | Pilot | Tower, Atlas 123, my apologies. Copy |
| | | | that. Cleared for takeoff on Runway |
| | | | 27-Right. Departure frequency 118.1. |
| | | | Thank you. |

Other examples of anomalies which may be detected include: fires; bird strikes; runway potholes/obstructions; aircraft pressurization issues; emergency landings; extreme weather; declared emergencies; and aircraft being too close to one another.

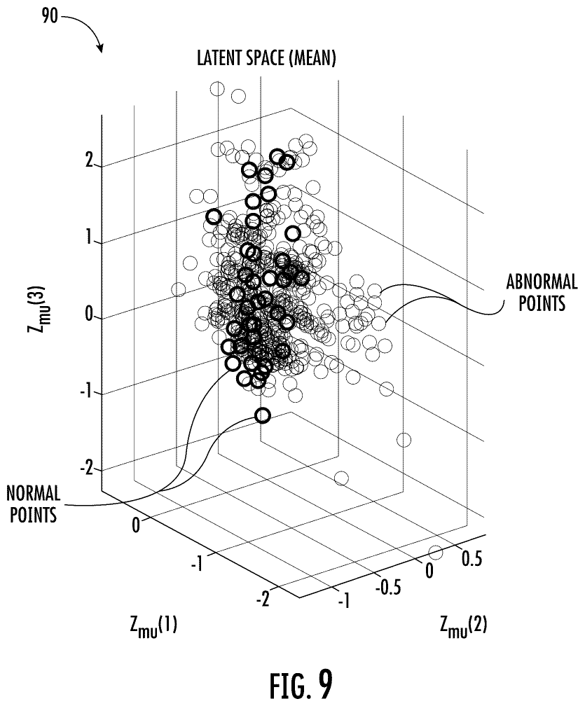

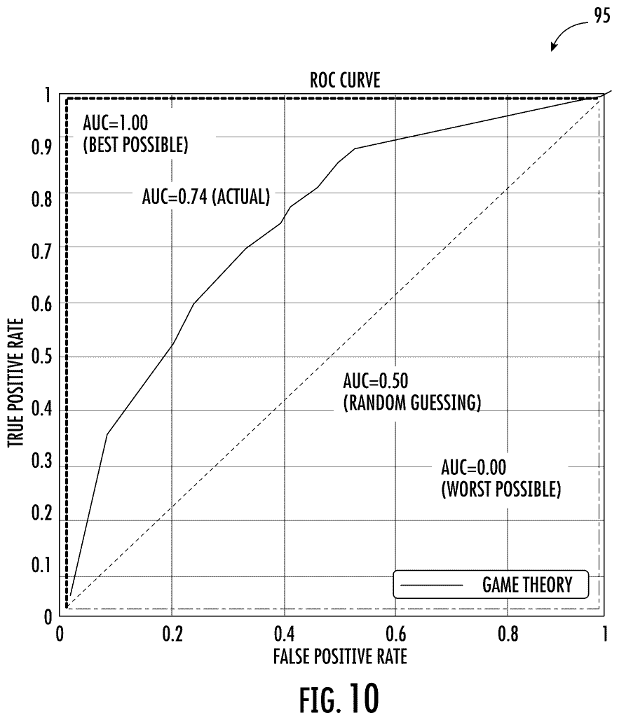

Evaluation results of the example text analytics anomaly detection system 30 are now described. First, the samples in the test data set were plotted within the learned VAE latent space. The 3D latent space is constructed from the principal component coefficients. The graph 90 of FIG. 9 shows the latent space for the mean encoding characterized by the first three principal component metrics.

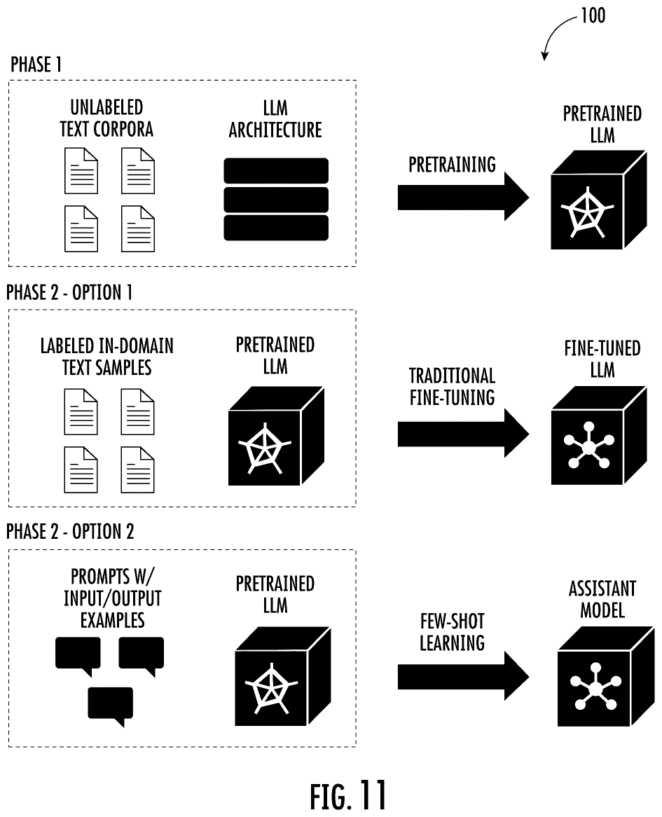

Referring additionally to the ROC curve 95 of FIG. 10, we can see that the AUC value is 0.74 or 74%. This demonstrates that the majority of normal air traffic conversations are correctly classified as normal, and that the majority of anomalous air traffic conversations are correctly classified as anomalous.

The above-described approach may also be used to implement the Operational Regulatory Framework, and factor that into the anomaly detection pipeline also through the use of LLMs. Additionally, the text analytics anomaly detection pipeline described above generates a nominal or off-nominal classification after processing the entirety of a conversational exchange, but for real-time ATC decision-making a nominal/off-nominal judgment may be made after each individual turn in a conversation. Furthermore, LLMs combined with human factor considerations may be incorporated to generate an appropriate alert (e.g., auditory signal, visual cue, natural language response with recommended actions) to concisely convey the alerts and recommended actions to all involved parties without distracting from other essential stimuli.

In some example embodiments, the processor 35 may also be configured to determine aircraft approximate locations from the text data. For example, a pilot may identify an aircraft by its call sign along with distance, heading, and altitude when approaching a navigation aid or airport. Data from onboard electronics (e.g., GPS geolocation data) could be collected as well in some embodiments. The processor 35 may account for the determined locations and projected future locations in anomaly determinations, such as aircraft being too close to one another, for example.

In some embodiments, discrepancies or degradations in audio communications may warrant the use of a modified conformance scoring by the processor 35. This approach may provide the ability to grade “shared cognition” between the air crew and ground controller coupled with degraded voice-communication protocol conformance. This will start with a pro-forma dialogue that generally includes the following components:
a. Who I'm calling;
b. What & Who I am;
c. Where I am; and
d. What I want.

By way of example, an aircraft might initiate with the following call:
a. Potomac Approach
b. Citation November 123 Alpha Bravo
c. Descending through Flight Level 250 for 20,000 on the Philipsburg Transition
d. Inbound for Manassas using the Privo Three Arrival

In such case, the initial response may come in with a relatively high degree of conformance as follows:
a. November 123 Alpha Bravo
b. Potomac Approach
c. Cleared for the Privo Three Arrival to Manassas; Proceed direct JARAF; Descend and maintain FL 180; Expect vectors at TWEAK

At this point, the response from the flight deck may depart from conformance significantly. For example the flight crew might reply:
3 Alpha Bravo; direct JARAF; 18,000.

Rather than simply parsing a sentence or phrase for meaning, the AI solver may instead “fill in the blank(s)” to compile content based on the provided words, and then convolve the VAE latent space content contextually with an air-navigation operational framework that was authorized by an air traffic controller during precursor elements of the air-ground communication sequence.

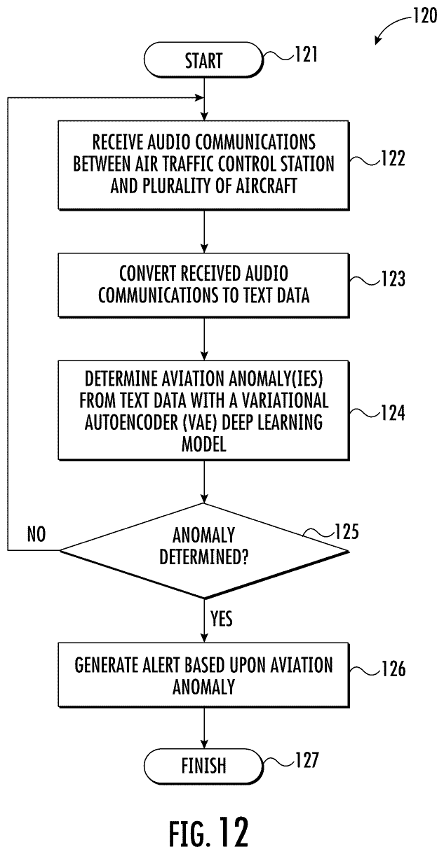

Turning now to the flow diagram 120 of FIG. 12, beginning at Block 121, a related aviation anomaly detection method may include receiving audio communications between an air traffic control station 32 and a plurality of aircraft 33 at the interface 31 (Block 122), and converting the received audio communications from the interface to text data at a speech-to-text converter 34 (Block 123). The method may further include using the processor 35 to determine one or more aviation anomalies from the text data with a VAE deep learning model, at Blocks 124-125, and generate an alert based upon the at least one aviation anomaly, at Block 126, as discussed further above. The method of FIG. 12 illustratively concludes at Block 127.

A related non-transitory computer-readable medium may have computer-executable instructions for causing the processor 35 to perform steps including receiving text data converted from audio communications between the air traffic control station 32 and aircraft 33. The steps may further include determining one or more aviation anomalies from the text data with a VAE deep learning model, and generating an alert based upon the at least one aviation anomaly, as discussed further above.

Many modifications and other embodiments will come to the mind of one skilled in the art having the benefit of the teachings presented in the foregoing descriptions and the associated drawings. Therefore, it is understood that the disclosure is not to be limited to the specific embodiments disclosed, and that modifications and embodiments are intended to be included within the scope of the appended claims.

1. An aviation anomaly detection system comprising:
an interface configured to receive audio communications between an air traffic control station and a plurality of aircraft;
a speech-to-text converter configured to convert the received audio communications from the interface to text data; and
a processor configured to
determine at least one aviation anomaly from the text data with a variational autoencoder (VAE) deep learning model, and
generate an alert based upon the at least one aviation anomaly.

2. The aviation anomaly detection system of claim 1 wherein the VAE deep learning model comprises a plurality of VAE deep learning models including at least some of an Adaptive Moment Estimation (ADAM) deep learning VAE model, a Stochastic Gradient Descent with Momentum (SGDM) deep learning VAE model, and a root mean square propagation (RMSProp) deep learning VAE model.

3. The aviation anomaly detection system of claim 2 wherein the processor is configured to select a given VAE deep learning model from among the plurality thereof based upon a game theory reward matrix.

4. The aviation anomaly detection system of claim 1 wherein the at least one aviation anomaly comprises at least one of a pilot readback error and a pilot deviation error.

5. The aviation anomaly detection system of claim 1 wherein the processor is further configured to determine aircraft locations from the text data, and determine the at least one aviation anomaly based upon relative positions of determined aircraft locations.

6. The aviation anomaly detection system of claim 1 wherein the VAE deep learning model is trained based upon a plurality of air traffic communications messages generated from a machine learning (ML) large language model (LLM).

7. The aviation anomaly detection system of claim 1 wherein the interface is configured to receive aircraft ground control audio communications and air route control audio communications.

8. An aviation anomaly detection method comprising:
receiving audio communications between an air traffic control station and a plurality of aircraft at an interface;
converting the received audio communications from the interface to text data at a speech-to-text converter; and
using a processor to
determine at least one aviation anomaly from the text data with a variational autoencoder (VAE) deep learning model, and
generate an alert based upon the at least one aviation anomaly.

9. The method of claim 8 wherein the VAE deep learning model comprises a plurality of VAE deep learning models including at least some of an Adaptive Moment Estimation (ADAM) deep learning VAE model, a Stochastic Gradient Descent with Momentum (SGDM) deep learning VAE model, and a root mean square propagation (RMSProp) deep learning VAE model.

10. The method of claim 9 further comprising using the processor to select a given VAE deep learning model from among the plurality thereof based upon a game theory reward matrix.

11. The method of claim 8 wherein the at least one aviation anomaly comprises at least one of a pilot readback error and a pilot deviation error.

12. The method of claim 8 further comprising use of the processor to determine aircraft locations from the text data, and determine the at least one aviation anomaly based upon relative positions of determined aircraft locations.

13. The method of claim 8 further comprising using the processor to train the VAE deep learning model based upon a plurality of air traffic communications generated from a machine learning (ML) large language model (LLM).

14. The method of claim 8 wherein receiving comprises receiving aircraft ground control audio communications and air route control audio communications at the interface.

15. A non-transitory computer-readable medium having computer-executable instructions for causing a processor to perform steps comprising:
receiving text data converted from audio communications between an air traffic control station and a plurality of aircraft;
determining at least one aviation anomaly from the text data with a variational autoencoder (VAE) deep learning model; and
generating an alert based upon the at least one aviation anomaly.

16. The non-transitory computer-readable medium of claim 15 wherein the VAE deep learning model comprises a plurality of VAE deep learning models including at least some of an Adaptive Moment Estimation (ADAM) deep learning VAE model, a Stochastic Gradient Descent with Momentum (SGDM) deep learning VAE model, and a root mean square propagation (RMSProp) deep learning VAE model.

17. The non-transitory computer-readable medium of claim 16 wherein the steps comprise causing the processor to select a given VAE deep learning model from among the plurality thereof based upon a game theory reward matrix.

18. The non-transitory computer-readable medium of claim 15 wherein the at least one aviation anomaly comprises at least one of a pilot readback error and a pilot deviation error.

19. The non-transitory computer-readable medium of claim 15 wherein the steps comprise causing the processor to determine aircraft locations from the text data, and determine the at least one aviation anomaly based upon relative positions of determined aircraft locations.

20. The non-transitory computer-readable medium of claim 15 wherein the steps comprise causing the processor to train the VAE deep learning model based upon a plurality of air traffic communications generated from a machine learning (ML) large language model (LLM).

21. The non-transitory computer-readable medium of claim 15 wherein receiving comprises receiving aircraft ground control audio communications and air route control audio communications at the interface.
